(19) United States
(12) Patent Application Publication
(10) Pub. No.: US 2026/0307277 A1
(43) Pub. Date: Oct. 8, 2026

(54) ROBOT DIGIT JOINT DIFFERENTIAL

(71) Applicant: Sanctuary Cognitive Systems Corporation, Vancouver (CA)

(72) Inventors: Connor Richard Shannon, Vancouver (CA); Kritika Joshi, Vancouver (CA); Tadas Mitkus, Vancouver (CA)

(21) Appl. No.: 19/638,459

(22) Filed: Apr. 3, 2026

Related U.S. Application Data
(60) Provisional application No. 63/785,593, filed on Apr. 8, 2025.

(51) Int. Cl. B25J 17/02; B25J 19/00

(52) U.S. Cl. CPC B25J 17/0258; B25J 19/0029

(57) ABSTRACT

A robotic digit includes a digit base, a gimbal coupled to the digit base, and a digit segment coupled to the gimbal. An actuator is coupled to the digit base. An input link is coupled to the gimbal and to an output of the actuator. The input link is movable relative to the gimbal by movement of the actuator output. An orthogonal joint couples the input link to the digit segment.

### FIELD

The field generally relates to robotic structures and particularly to mechanical digits for robotic hands.

### BACKGROUND

Robots are machines that can sense their environments and perform tasks autonomously or semi-autonomously or via teleoperation. A humanoid robot is a robot or machine having an appearance and/or character resembling that of a human. There is considerable interest in humanoid robots that can function as collaborators with humans in diverse applications, such as construction, manufacturing, monitoring, exploration, learning, and entertainment. Such robots may perform tasks in a similar way to how humans perform tasks.

Robots typically have robotic hands (also called end effectors) for interaction with an environment. Some robotic hands have robotic digits that can mimic human fingers. The robotic digits can include joints having the functionalities of joints in human hands (such as knuckles). The complexity of the tasks that can be performed with such robotic hands can depend on the degrees of freedom provided by the joints and the extent to which the movement of the joints can be accurately and reliably controlled.

### SUMMARY

In a representative example, a robotic digit includes a digit base, a gimbal coupled to the digit base, and a first digit segment coupled to the gimbal. A first actuator is coupled to the digit base. The first actuator has a first actuator output. A first input link is coupled to the gimbal and the first actuator output. The first input link is movable relative to the gimbal by movement of the first actuator output. A first orthogonal joint couples the first input link to the first digit segment.

### BRIEF DESCRIPTION OF DRAWINGS

FIG. 1 is a projection view of a robotic digit.

FIG. 2 is a projection view of the robotic digit of FIG. 1 with some parts removed to show a gimbal coupled to a digit base.

FIG. 3 is a projection view of the robotic digit of FIG. 1 with some parts removed to show actuators pivotably coupled to a digit base.

FIG. 4 is a projection view of the robotic digit of FIG. 1 with some parts removed to show input links mounted on a gimbal.

FIG. 5 is another projection view of the robotic digit of FIG. 1 shown from a proximal end.

FIG. 6 is a cross-sectional view of a portion of the robotic digit of FIG. 1.

FIG. 7 is a projection view illustrating flexion of the robotic digit of FIG. 1.

FIG. 8 is a projection view illustrating abduction of the robotic digit of FIG. 1.

### DETAILED DESCRIPTION

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or linked and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Described herein is a robotic digit that can emulate movements and poses of a humanoid finger. The robotic digit uses a joint differential including two input links that can be coupled to the outputs of two actuators. Each input link is coupled to a digit segment by an orthogonal joint, which substantially eliminates side load on the input link. The actuators can be standalone actuators that can be pivotably mounted, which can avoid side loads on the actuators as the actuators move through a range of motions.

### Example II—Robotic Digit

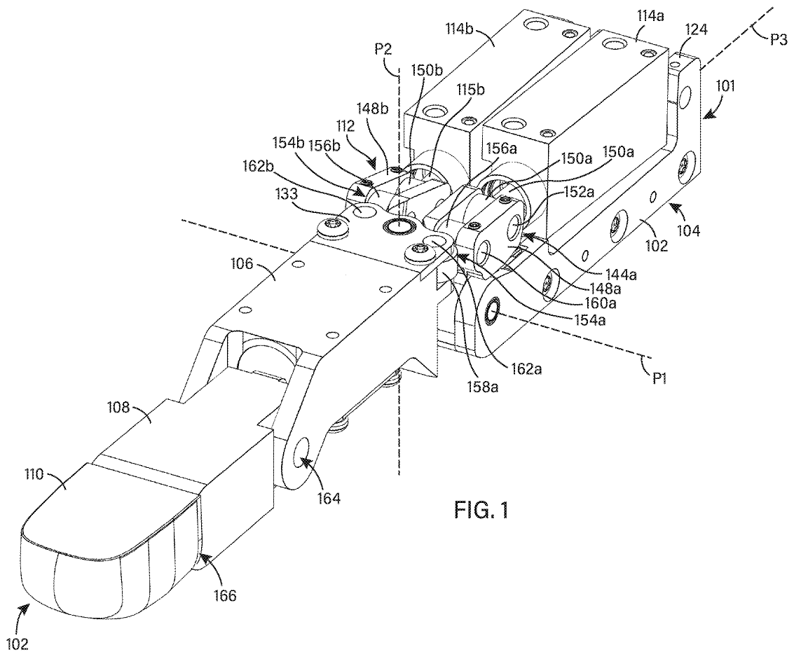

FIG. 1 illustrates an example robotic digit 100 (or robotic finger) extending from a proximal end 101 to a distal end 102. The robotic digit 100 includes a digit base 104 (or finger base), which may be attached to or form part of a palm of a hand. The robotic digit 100 includes a proximal digit segment 106, an intermediate digit segment 108, and a distal digit segment 110. Although three digit segments are illustrated, the robotic digit may have fewer than or greater than three digit segments.

A proximal joint 112 (corresponding to a metacarpophalangeal (MCP) joint in a humanoid finger) is formed between the proximal digit segment 106 and the digit base 104. The proximal joint 112 is a compound joint that enables movement of the proximal digit segment 106 about multiple axes (e.g., any combination of movements about a flexion axis P1 and an abduction axis P2). The proximal joint 112 can be actuated by actuators 114a, 114b, which as shown are coupled to the digit base 104.

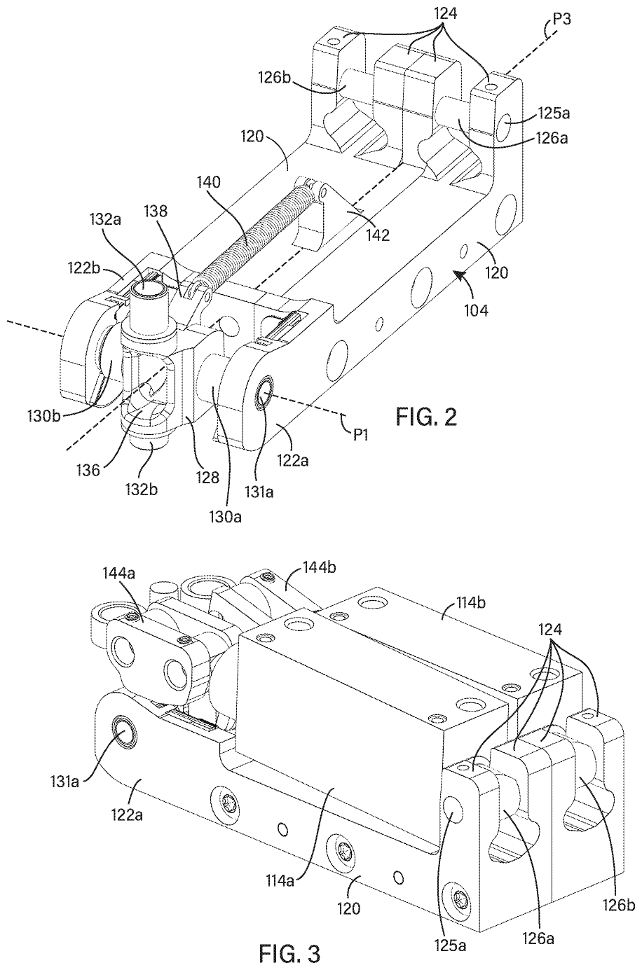

As shown more clearly in FIG. 2, the digit base 104 can include a support base 120 and support arms 122a, 122b projecting distally from a distal end of the support base 120. The support arms 122a, 122b are parallel to an axial axis P3 of the digit base 104 and spaced apart in a direction transverse to the axial axis P3. Proximal posts 124 (or a proximal wall) may project from a proximal end of the support base 120 in a direction orthogonal to a plane of the support base 120. As shown in FIGS. 1 and 3, the actuators 114a, 114b are mounted on the support base 120 with their bases facing the proximal posts 124.

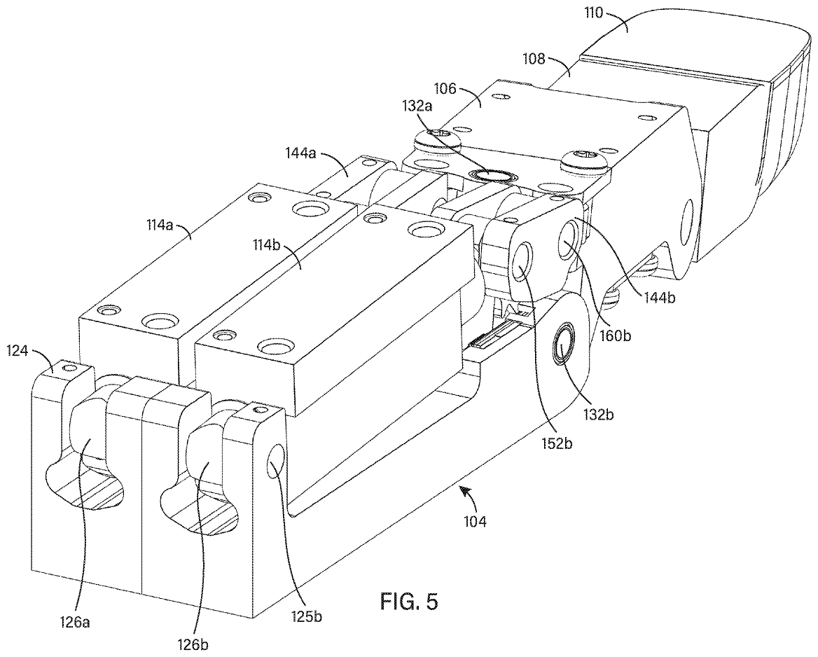

The bases of the actuators 114a, 114b can be pivotably coupled to the proximal posts 124. For example, as shown more clearly in FIGS. 3 and 5, the base of the actuator 114a (114b) can include a protuberance 126a (126b) that can be positioned between a pair of the proximal posts 124. The protuberance 126a (126b) can be mounted on a pivot shaft 125a (125b) that is supported at opposite ends by the pair of proximal posts 124. In some examples, the pivot shaft 125a (125b) may extend through a bore (or a bushing fitted in a bore) of the protuberance 126a (126b). Alternatively, the pivot shaft 125a (125b) may be formed by lateral arms attached to opposite sides of the protuberance 126a (126b). The pivots formed at the bases of the actuators 114a, 114b can substantially eliminate side loads on the actuators as the actuator outputs move through a range of motions.

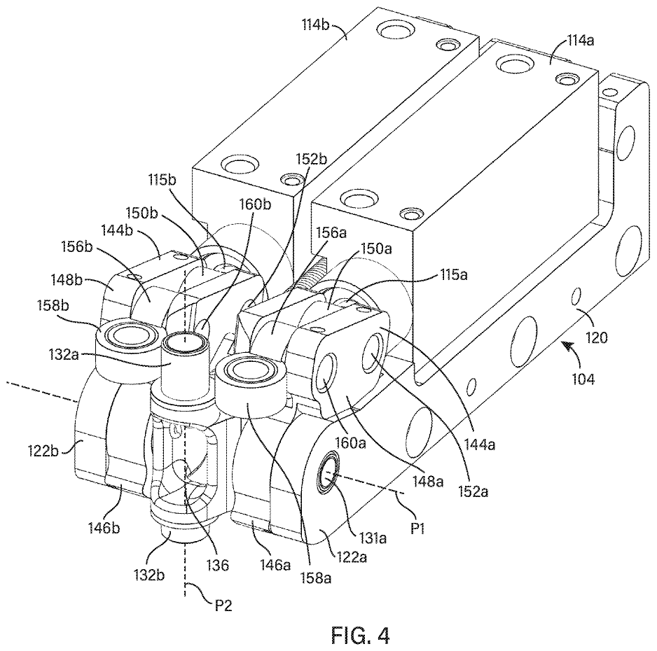

The proximal joint 112 includes a gimbal 128 (shown more clearly in FIGS. 2 and 4) arranged between the support arms 122a, 122b and supported for rotation about the flexion axis P1. As shown in FIG. 2, the flexion axis P1 is orthogonal to the axial axis P3 of the digit base 104. The gimbal 128 includes gimbal arms 130a, 130b projecting from opposite sides of the gimbal 128. End portions 131a, 131b (see 131b in FIG. 3) of the gimbal arms 130a, 130b are received in corresponding holes in the adjacent support arms 122a, 122b. The end portions may be mounted in the holes with bushings. The gimbal arms 130a, 130b are axially aligned along the flexion axis P1 and define a pivot having a pivot axis coinciding with the flexion axis P1.

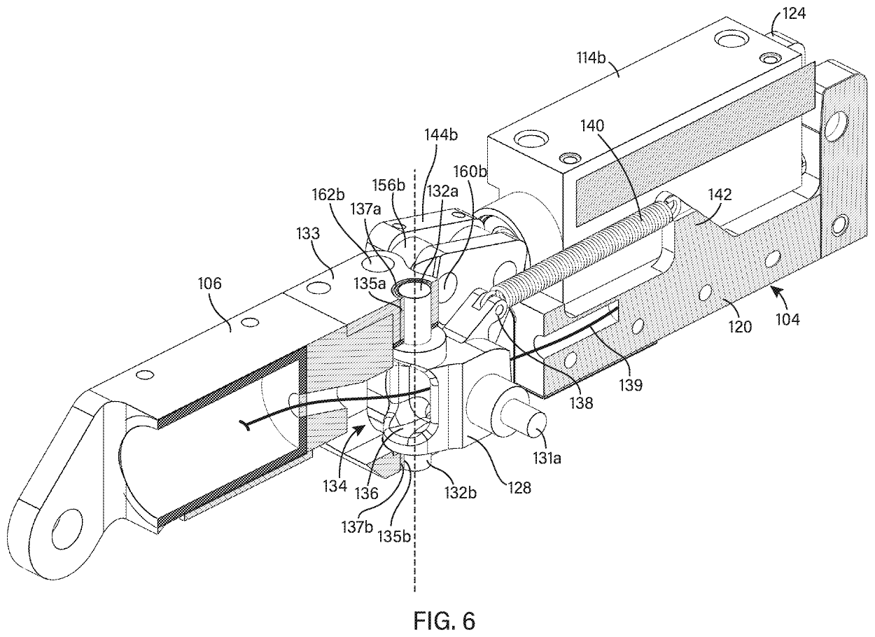

The gimbal 128 includes gimbal arms 132a, 132b projecting from opposite ends of the gimbal 128. The gimbal arms 132a, 132b are arranged orthogonally to the gimbal arms 130a, 130b. As shown more clearly in FIG. 6, a portion of the gimbal 128 including the gimbal arms 130a, 130b is received in an opening 134 of the proximal end portion 133 of the proximal digit segment 106. The gimbal arms 132a, 132b are received in corresponding holes in the adjacent portions of the proximal end portion 133. The gimbal arms 132a, 132b may be mounted in the holes with bushings or bearings (e.g., the gimbal arm 132a is mounted in the hole 135a with a thrust bearing 137a, and the gimbal arm 132b is mounted in the hole 135b with a bushing 137b). The gimbal arms 132a, 132b are axially aligned along the abduction axis P2 and define a pivot having a pivot axis coinciding with the abduction axis P2.

In some examples, as shown in FIGS. 2 and 4-6, the gimbal 128 can have a central opening 136, which can allow line structures (e.g., tubes and electrical wires) to be routed from the digit base 104 to the proximal digit segment 106 (see the line 139 representing line structures in FIG. 6).

In some examples, as shown in FIGS. 2 and 4-6, the gimbal 128 can have an anchor 138 to which one end of a spring 140 can be attached. The other end of the spring 140 is attached to an anchor 142 (see FIGS. 2 and 6) on the support base 120. The spring 140 is arranged to return the gimbal 128 to a neutral position.

The proximal joint 112 includes input links 144a, 144b mounted on the gimbal 128, which effectively couples the input links 144a, 144b to the support arms 122a, 122b. Joints are formed between the outputs of the actuators 114a, 114b and the inputs links 144a, 144b and between the proximal digit segment 106 and the input links 144a, 144b to allow movement of the outputs of the actuators 114a, 114b to be translated to movement of the proximal digit segment 106 about the flexion axis P1 or the abduction axis P2.

As shown more clearly in FIG. 4, the input link 144a (144b) includes a hub 146a (146b) and a yoke 148a (148b) projecting from the hub 146a (146b). The hub 146a (146b) is positioned between a side of the gimbal 128 and the adjacent support arm 122a (122b). The gimbal arm 130a (130b) (see FIG. 2) extends through a bore of the hub 146a (146b) or through a bushing fitted in the bore of the hub 146a (146b). With this arrangement, the input link 144a (144b) can pivot on the respective gimbal arm 130a (130b) and about the flexion axis P1.

The yoke 148a (148b) is coupled to the output 115a (115b) of the respective actuator 114a (114b). For example, the output 115a (115b) of the actuator 114a (114b) can include a connector end 150a (150b) (e.g., a rod end) having a bore. The connector end 150a (150b) can be disposed between the prongs of the yoke 148a (148b). A pivot shaft 152a (152b) can extend through the bore (or through a bushing fitted in the bore) and can be supported at opposite ends by the prongs of the yoke 148a (148b). The pivot shaft 152a (152b) defines a pivot between the connector end 150a (150b) and the input link 144a (144b). The pivot axis can be parallel to the flexion axis P1.

Returning to FIG. 1, the input link 144a (144b) is coupled to the proximal digit segment 106 by an orthogonal joint 154a (154b) that transmits motion from a plane of the input link 144a (144b) to a plane of the proximal digit segment 106. The orthogonal joint 154a (154b) can substantially reduce side load on the respective input link 144a (144b).

The orthogonal joint 154a (154b) includes a first connector link 156a (156b) disposed on a pivot shaft 160a (160b in FIG. 5) that is supported on opposite ends by the yoke 148a (148b) of the respective input link 144a (144b). The axial axis of the pivot shaft 160a (160b) can be parallel to the flexion axis P1 and to the axial axis of the pivot shaft 152a (152b in FIG. 5) at the connector end 150a (150b). The pivot shaft 160a (160b) may extend through a bushing fitted in a bore of the first connector link 156a (156b).

The orthogonal joint 154a (154b) includes a second connector link 158a (158b in FIG. 4) disposed on a pivot shaft 162a (162b) that is supported by the proximal end portion 133 of the proximal digit segment 106. The axial axis of the pivot shaft 162 (162b) can be parallel to the abduction axis P2. The pivot shaft 162a (162b) may extend through a bushing fitted in a bore of the second connector link 158a (158b).

The actuators 114a, 114b can be linear actuators, which can be electric linear actuators or fluid-based linear actuators. In some examples, the actuators 114a, 114b are double-acting hydraulic cylinders with ports for injecting fluid on either side of pistons disposed inside the hydraulic cylinders. The actuator outputs 115a, 115b can be piston rods coupled to the pistons inside the hydraulic cylinders.

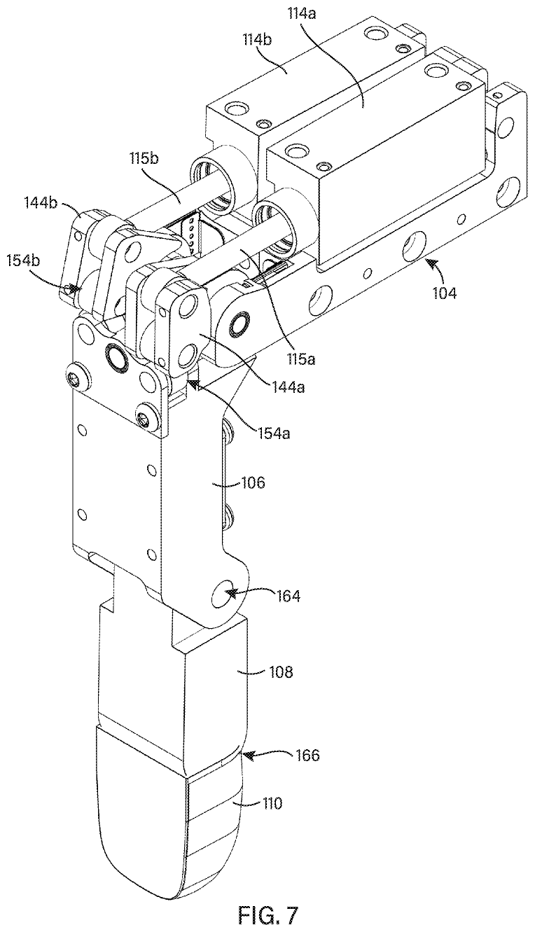

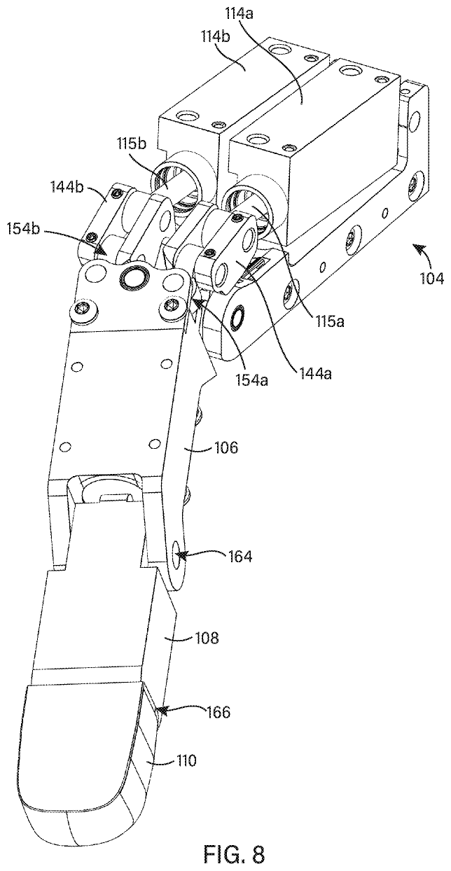

Movement of the output 115a of the actuator 114a causes rotational displacement of the input link 144a about the flexion axis P1. Similarly, movement of the actuator 114b causes rotational displacement of the input link 114b about the flexion axis P1. If the actuators 114a, 114b are moving in the same direction such that the input links 114a, 114b are rotationally displaced in the same direction, the gimbal 128 and the proximal digit segment 106 rotate about the flexion axis P1, as shown in FIG. 7. If the actuators 114a, 114b are moving in opposite directions such that the input links 114a, 114b are rotationally displaced in opposite directions, the proximal digit segment 106 rotates about the abduction axis P2, as shown in FIG. 8. The proximal digit segment 106 can also rotate about the abduction axis P2 if the actuators 114a, 114b are moving in the same direction but at different speeds (or if one of the actuators 114a, 114b is not moving while the other is moving).

The intermediate digit segment 108 is coupled to the proximal digit segment 106 by an intermediate joint 164, which in the example is illustrated as a pivot joint. The intermediate joint 164 may be actuated using any suitable mechanism. For example, the proximal digit segment 106 may carry an actuator whose output can be configured to actuate the intermediate joint 164. In another example, the intermediate joint may be actuated by a cable mechanism, such as disclosed, for example, in U.S. patent application Ser. No. 19/087,196 (“Cable-Coupled Robotic Finger Actuation”). In other examples, the intermediate joint 164 may be other than a pivot joint. For example, the intermediate joint 164 may be a rolling surface joint, such as disclosed, for example, in U.S. patent application Ser. No. 17/491,577 (“Systems, Devices, and Methods for Robotic End Effectors”).

The distal digit segment 110 is coupled to the intermediate digit segment 108 by a distal joint 166, which in the illustrated example is a fixed joint. In other examples, the distal digit segment 110 may be coupled to the intermediate digit segment 108 by a movable joint, such as a pivot joint or a rolling surface joint, which may be actuated.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A robotic digit comprising: a digit base; a gimbal coupled to the digit base; a first digit segment coupled to the gimbal; a first actuator coupled to the digit base, the first actuator having a first actuator output; a first input link coupled to the gimbal and the first actuator output, the first input link movable relative to the gimbal by movement of the first actuator output; and a first orthogonal joint coupling the first input link to the first digit segment.

Example 2: A robotic digit of according to Example 1, wherein the gimbal is movable relative to the digit base about a first axis, and wherein the first digit segment is movable relative to the gimbal about a second axis orthogonal to the first axis.

Example 3: A robotic digit of according to Example 2, further comprising: a second actuator coupled to the digit base, the second actuator having a second actuator output; a second input link coupled to the gimbal and the second actuator output, the second input link movable relative to the gimbal by movement of the second actuator output; and a second orthogonal joint coupling the second input link to the first digit segment.

Example 4: A robotic digit of according to Example 3, wherein the first input link and the second input link are movable relative to the gimbal about the first axis.

Example 5: A robotic digit of according to Example 4, wherein movement of the first actuator output and the second actuator output in different directions or at different speeds causes movement of the first digit segment about the second axis.

Example 6: A robotic digit of according to Example 4, wherein movement of the first actuator output and the second actuator in same direction causes movement of the first digit segment about the first axis.

Example 7: A robotic digit of according to Example 3, wherein the gimbal comprises a first pivot coupled to the digit base, wherein the first pivot defines the first axis.

Example 8: A robotic digit of according to Example 6, wherein the first input link and the second input link are disposed on the first pivot and on opposite sides of the gimbal.

Example 9: A robotic digit of according to Example 6, wherein the gimbal comprises a second pivot coupled to the first digit segment, wherein the second pivot defines the second axis.

Example 10: A robotic digit of according to Example 8, wherein the gimbal comprises an opening for passage of one or more line structures from the digit base to the first digit segment.

Example 11: A robotic digit of according to Example 3, wherein a first pivot joint is formed between the first actuator output and the first input link, and wherein a second pivot joint is formed between the second actuator output and the second input link.

Example 12: A robotic digit of according to Example 3, wherein the first actuator and the second actuator are pivotably coupled to the digit base.

Example 13: A robotic digit of according to Example 3, wherein the first actuator and the second actuator are hydraulic actuators.

Example 14: A robotic digit of according to Example 2, wherein the first orthogonal joint comprises a first connector link mounted on a first pivot coupled to the first input link and a second pivot mounted on a second pivot coupled to the first digit segment, wherein a pivot axis of the first pivot is orthogonal to a pivot axis of the second pivot.

Example 15: A robotic digit of according to Example 14, wherein the first pivot axis is parallel to the first axis, and wherein the second pivot axis is parallel to the second axis.

Example 16: A robotic digit of according to Example 1, further comprising at least one additional digit segment coupled to the first digit segment.

Example 17: A robotic digit of according to Example 2, further comprising a spring connecting the gimbal to the digit base, wherein the spring returns the gimbal to a neutral position.

Example 18: A robotic digit of according to Example 1, wherein the gimbal comprises an opening for passage of one or more line structures from the digit base to the first digit segment.

1. A robotic digit comprising:
a digit base;
a gimbal coupled to the digit base;
a first digit segment coupled to the gimbal;
a first actuator coupled to the digit base, the first actuator having a first actuator output;
a first input link coupled to the gimbal and the first actuator output, the first input link movable relative to the gimbal by movement of the first actuator output; and
a first orthogonal joint coupling the first input link to the first digit segment.

2. The robotic digit of claim 1, wherein the gimbal is movable relative to the digit base about a first axis, and wherein the first digit segment is movable relative to the gimbal about a second axis orthogonal to the first axis.

3. The robotic digit of claim 2, further comprising:
a second actuator coupled to the digit base, the second actuator having a second actuator output;
a second input link coupled to the gimbal and the second actuator output, the second input link movable relative to the gimbal by movement of the second actuator output; and
a second orthogonal joint coupling the second input link to the first digit segment.

4. The robotic digit of claim 3, wherein the first input link and the second input link are movable relative to the gimbal about the first axis.

5. The robotic digit of claim 4, wherein movement of the first actuator output and the second actuator output in different directions or at different speeds causes movement of the first digit segment about the second axis.

6. The robotic digit of claim 4, wherein movement of the first actuator output and the second actuator in the same direction causes movement of the first digit segment about the first axis.

7. The robotic digit of claim 3, wherein the gimbal comprises a first pivot coupled to the digit base, wherein the first pivot defines the first axis.

8. The robotic digit of claim 6, wherein the first input link and the second input link are disposed on the first pivot and on opposite sides of the gimbal.

9. The robotic digit of claim 6, wherein the gimbal comprises a second pivot coupled to the first digit segment, wherein the second pivot defines the second axis.

10. The robotic digit of claim 8, wherein the gimbal comprises an opening for passage of one or more line structures from the digit base to the first digit segment.

11. The robotic digit of claim 3, wherein a first pivot joint is formed between the first actuator output and the first input link, and wherein a second pivot joint is formed between the second actuator output and the second input link.

12. The robotic digit of claim 3, wherein the first actuator and the second actuator are pivotably coupled to the digit base.

13. The robotic digit of claim 3, wherein the first actuator and the second actuator are hydraulic actuators.

14. The robotic digit of claim 2, wherein the first orthogonal joint comprises a first connector link mounted on a first pivot coupled to the first input link and a second pivot mounted on a second pivot coupled to the first digit segment, wherein a pivot axis of the first pivot is orthogonal to a pivot axis of the second pivot.

15. The robotic digit of claim 14, wherein the first pivot axis is parallel to the first axis, and wherein the second pivot axis is parallel to the second axis.

16. The robotic digit of claim 1, further comprising at least one additional digit segment coupled to the first digit segment.

17. The robotic digit of claim 2, further comprising a spring connecting the gimbal to the digit base, wherein the spring returns the gimbal to a neutral position.

18. The robotic digit of claim 1, wherein the gimbal comprises an opening for passage of one or more line structures from the digit base to the first digit segment.
